(19) United States
(12) Patent Application Publication
(10) Pub. No.: US 2025/0117876 A1
(43) Pub. Date: Apr. 10, 2025

(54) CACHE MEMORY ARCHITECTURE AUGMENTATION FOR 3-DIMENSIONAL (3D) DATA

(71) Applicant: QUALCOMM Incorporated, San Diego, CA (US)

(72) Inventors: Shivansh RAO, San Diego, CA (US); Arunkumar NEHRUR RAVI, San Diego, CA (US); Gokce DANE, San Diego, CA (US); Ai-Mei HUANG, Zhubei (TW); Vasudev BHASKARAN, San Diego, CA (US); Anil Kumar GOKAVARAPU, San Diego, CA (US)

(21) Appl. No.: 18/481,909

(22) Filed: Oct. 5, 2023

(51) Int. Cl. G06T 1/60; G06T 15/00; G06T 17/10

(52) U.S. Cl. CPC G06T 1/60; G06T 15/005; G06T 17/10

(57) ABSTRACT

Aspects of the disclosure are directed to reordering a plurality of input block voxel indices in a cache memory. In accordance with one aspect, an apparatus including a create block configured to receive the plurality of input block voxel indices and configured to generate a reordered list based on the plurality of input block voxel indices; and an integrate block coupled to the create block, the integrate block configured to use the reordered list to deliver integrate depth data for generating a plurality of output block voxel indices. In accordance with one aspect, a method including reordering the plurality of input block voxel indices into a plurality of output block voxel indices using a separated set of input block voxel indices; and accessing the plurality of output block voxel indices to provide an augmented cache memory access.

### TECHNICAL FIELD

This disclosure relates generally to the field of cache memory architecture, and, in particular, to cache memory architecture augmentation for 3-dimensional data.

### BACKGROUND

An information processing system (e.g., a computing platform) relies on a memory hierarchy of different memory types to provide an optimal balance between memory access speed and storage capacity. One memory type used for particularly rapid memory access speed is a cache memory. The cache memory is typically organized using an optimized hardware architecture. However, certain applications, such as three-dimensional (3D) graphical processing, may not use the cache memory efficiently, resulting in an undesired memory hit ratio. Hence, one is motivated to provide a cache memory architecture augmentation which optimizes the ordering of 3D data in the cache memory.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides cache memory architecture augmentation for 3-D data. Accordingly, an apparatus including a create block configured to receive a plurality of input block voxel indices and configured to generate a reordered list based on the plurality of input block voxel indices; and an integrate block coupled to the create block, the integrate block configured to use the reordered list to deliver integrate depth data for generating a plurality of output block voxel indices. In one example, the apparatus further includes a select block coupled to the create block, the select block configured to send the plurality of input block voxel indices to the create block. In one example, the apparatus further includes a memory coupled to the create block, the memory configured for storing the plurality of input block voxel indices.

In one example, the create block includes a reordering block, the reordering block configured to generate the reordered list. In one example, the memory is configured to store one or more of the following: a depth image, one or more 3D voxels, a depth and voxel set, one or more voxels, a meta data buffer, an updated voxel, a color image, or an updated voxel with color. In one example, the integrate block includes a depth pass module, the depth pass module configured to receive a depth image and one or more 3D voxels, and the depth pass module further configured to generate a depth image data based on the depth image and the one or more 3D voxels. In one example, the depth pass module is further configured to deliver the depth image data to a meta data buffer. In one example, the meta data buffer is a component of the memory. In one example, integrate block includes a color pass module, the color pass module configured to receive the depth image data from the meta data buffer, and further configured to generate an updated voxels with color based on the depth image data. In one example, the color pass module includes a color cache memory, the color cache memory configured to receive a color image for the generation of the updated voxels with color.

Another aspect of the disclosure provides a method including reordering a plurality of input block voxel indices into a plurality of output block voxel indices using a separated set of input block voxel indices; and accessing the plurality of output block voxel indices to provide an augmented cache memory access. In one example, the method further includes separating the plurality of input block voxel indices to generate the separated set of input block voxel indices. In one example, the method further includes accepting the plurality of input block voxel indices from a cache memory. In one example, the cache memory is a component of a main memory.

In one example, each of the plurality of input block voxel indices provides an addressing label to a three-dimensional (3D) image data. In one example, the method further includes separating the 3D image data into N different grids. In one example, N is 16 different grids. In one example, neighboring input block voxel indices of the plurality of input block voxel indices in the 3D image data are placed in a same grid.

In one example, the method further includes dividing the plurality of input block voxel indices into a plurality of grids by grouping each of the plurality of input block voxel indices according to each first spatial coordinate (x) of the each plurality of input block voxel indices. In one example, the method further includes dividing the plurality of input block voxel indices into a plurality of grids by grouping each of the plurality of input block voxel indices according to each second spatial coordinate (y) of the each plurality of input block voxel indices. In one example, the method further includes dividing the plurality of input block voxel indices into a plurality of grids by grouping each of the plurality of input block voxel indices according to each third spatial coordinate (z) of the each plurality of input block voxel indices.

In one example, the method further includes separating the plurality of input block voxel indices by determining a minimum and a maximum of a plurality of spatial coordinates of the plurality of input block voxel indices.

In one example, the plurality of spatial coordinates is one of: a) a plurality of a first spatial coordinates (x); b) a plurality of a second spatial coordinates (y); or c) a plurality of a third spatial coordinates (z). In one example, the method further includes dividing a bucket size based on a ratio of a difference of the maximum and the minimum over a quantity of tiles.

Another aspect of the disclosure provides an apparatus including means for accepting a plurality of input block voxel indices from a cache memory; means for separating the plurality of input block voxel indices to generate a separated set of input block voxel indices; means for reordering the plurality of input block voxel indices into a plurality of output block voxel indices using the separated set of input block voxel indices; and means for accessing the plurality of output block voxel indices to provide an augmented cache memory access. In one example, the apparatus further includes means for separating a 3-Dimensional (3D) image data into 16 different grids, wherein neighboring input block voxel indices of the plurality of input block voxel indices in the 3D image data are placed in a same grid.

In one example, the apparatus further includes means for separating the plurality of input block voxel indices by determining a minimum and a maximum of a plurality of spatial coordinates of the plurality of input block voxel indices, wherein the plurality of spatial coordinates is one of: a) a plurality of a first spatial coordinates (x); b) a plurality of a second spatial coordinates (y); or c) a plurality of a third spatial coordinates (z). In one example, the apparatus further includes means for dividing a bucket size based on a ratio of a difference of the maximum and the minimum over a quantity of tiles.

Another aspect of the disclosure provides a non-transitory computer-readable medium storing computer executable code, operable on a device including at least one processor and at least one memory coupled to the at least one processor, wherein the at least one processor is configured to implement reordering a plurality of input block voxel indices in a cache memory, the computer executable code including instructions for causing a computer to accept the plurality of input block voxel indices from the cache memory; instructions for causing the computer to separate the plurality of input block voxel indices to generate a separated set of input block voxel indices; instructions for causing the computer to reorder the plurality of input block voxel indices into a plurality of output block voxel indices using the separated set of input block voxel indices; and instructions for causing the computer to access the plurality of output block voxel indices to provide an augmented cache memory access.

In one example, the non-transitory computer-readable medium further includes instructions for causing the computer to separate the plurality of input block voxel indices by determining a minimum and a maximum of a plurality of spatial coordinates of the plurality of input block voxel indices, wherein the plurality of spatial coordinates is one of: a) a plurality of a first spatial coordinates (x); b) a plurality of a second spatial coordinates (y); or c) a plurality of a third spatial coordinates (z); and instructions for causing the computer to divide a bucket size based on a ratio of a difference of the maximum and the minimum over a quantity of tiles.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates a first example information processing system.

FIG. 2 illustrates an example 3-Dimensional (3D) volume graphical representation with a voxel as a function of three spatial coordinates (x, y, z).

FIG. 3A illustrates a second example information processing system.

FIG. 3B illustrates the example information processing system of FIG. 3A with added detail to the integrate block, the create block and the main memory.

FIG. 4A illustrates a third example information processing system.

FIG. 4B illustrates the example information processing system of FIG. 4A with added detail to the integrate block, the create block and the main memory.

FIG. 5 illustrates an example preprocessing block.

FIG. 6 illustrates an example of a miss performance for an average case and a worst case.

FIG. 7 illustrates an example of a bandwidth performance for an average case and a worst case.

FIG. 8 illustrates an example flow diagram for reordering a plurality of input block voxel indices in a cache memory.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In one example, memory units of an information processing system may form a memory hierarchy with a local memory unit or an internal cache memory unit dedicated to each slice, a global memory unit shared among all slices and other memory units with various degrees of shared access. For example, a first level cache memory or L1 cache memory may be a memory unit dedicated to a single processing engine and may be optimized with a faster memory access time at the expense of storage space. For example, a second level cache memory or L2 cache memory may be a memory unit which is shared among more than one processing engine and may be optimized to provide a larger storage space at the expense of memory access time. In one example, each slice or each processing engine includes a dedicated internal cache memory.

In one example, the memory hierarchy may be organized as a cascade of cache memory units with the first level cache memory, the second level cache memory and other memory units with changing (e.g., increasing) storage space and slower memory access time going up the memory hierarchy. In one example, other cache memory units in the memory hierarchy may be introduced which are intermediate between existing memory units.

In one example, the information processing system may need to access data which is stored somewhere in the memory hierarchy. In one example, for fastest access, a memory read (i.e., a directive to retrieve requested data from memory) may be attempted first with a cache memory. For example, if the requested data is actually stored in the cache memory, this action is known as a cache memory hit or a memory hit (i.e., a hit). For example, if the requested data is not stored in the cache memory, this action is known as a cache memory miss or a memory miss (i.e., a miss) and the requested data must be retrieved from the main memory.

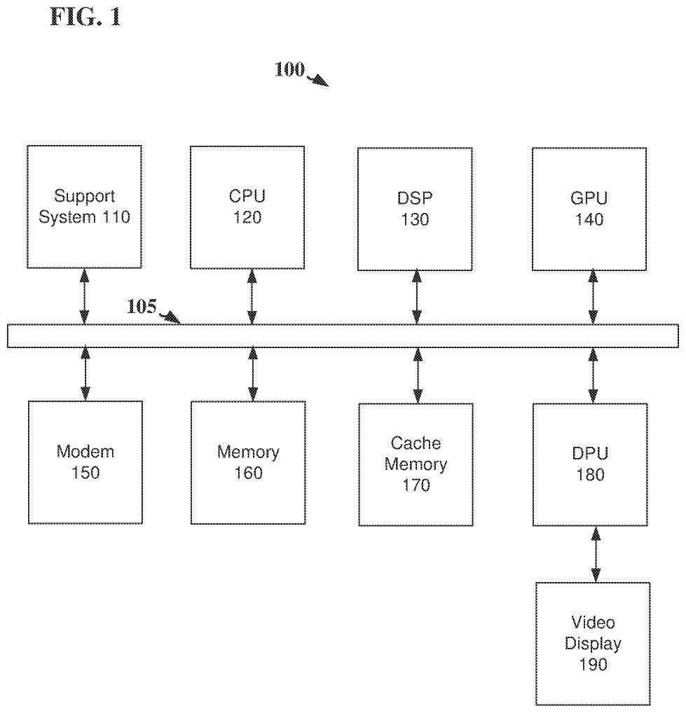

FIG. 1 illustrates a first example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information. For example, the memory 160 and/or the cache memory 170 may be shared among the CPU 120, the GPU 140 and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines.

In one example, a hardware design for an information processing system may employ a cache memory with a large memory capacity (e.g., a random-access memory (RAM) with 192 bits×1024 rows×16 banks) as part of a memory hierarchy. For example, the cache memory is a small, fast access memory which is separate from main memory in the information processing system. For example, the cache memory design is optimized solely on hardware constraints. In one example, the cache memory may have a large area, a high bandwidth, high power consumption, high outstanding transaction (OT) ratio, and a low memory hit ratio. For example, memory hit ratio is the fraction of successful memory retrieval events relative to all memory retrieval attempts. For example, outstanding transactions include pending tasks that are not completed.

In one example, the cache memory design may be modified to produce an augmented cache memory design. The augmented cache memory design may incorporate software preprocessing and software post-processing actions. In one example, software processing may be executed between hardware processing steps (e.g., select block and integrate block) which may result in changed area, changed bandwidth, changes power consumption, changed OT ratio (e.g., reduced area, reduced bandwidth, reduced power consumption, reduced OT ratio) and a changed (e.g., higher) memory hit ratio (i.e., higher cache memory performance).

In one example, the augmented cache memory design may partition (e.g., separate) block voxel indices into 2D grids using a reordering block. In one example, the reordering block orders voxels which are neighbors in 3D space into one 2D grid. For example, using the same hardware design, bandwidth and memory hit ratio may be modified by an approximate factor of seven. For example, using a modified hardware design and same area, the bandwidth and memory hit ratio may be modified by an approximate factor of 62. For example, using the modified hardware design and half area, the memory hit ratio may be modified by an approximate factor of 4. For example, the OT ratio may be modified by approximately 30% for the techniques mentioned herein. In one example, a 2D grid is a two-dimensional array of values. One skilled in the art would understand that the term “indices” used herein may also be spelled as “indexes”.

In one example, the augmented cache memory design is not restricted toward 3D reconstruction, but also for other computer vision (CV) applications such as plane detection, occlusion rendering, semantic segmentation, etc. which use an internal cache memory for storage of depth-pixel/red green blue (RGB) color values.

In one example, three-dimensional (3D) image processing involves generation, manipulation, transmission and display of 3D image data as a function of three dimensions or spatial coordinates, for example, (x, y, z). In one example, each input block voxel index of the plurality of input block voxel indices provides an addressing label to the three-dimensional (3D) image data. In one example, each element of 3D image data may be addressed or indexed by a particular spatial coordinate known as a volume element or voxel.

In one example, the voxel is a three-dimensional analog of a two-dimensional pixel (e.g., picture element). For example, 3D image data may represent a plurality of color planes where each color plane is one spectral component of a 2D picture. For example, a first spatial coordinate (e.g., x) and a second spatial coordinate (e.g., y) may be two-dimensional indices of a single color plane for a third spatial coordinate which is fixed (e.g., z=constant). For example, the plurality of color planes may be three color planes where each color plane is a unique spectral component of the 2D picture (e.g., red, green, blue (RGB)).

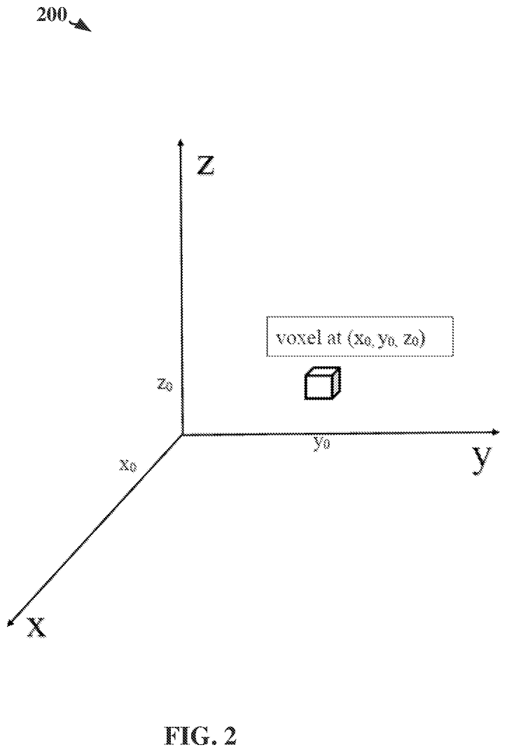

In one example, the 3D image data may be graphically represented as a three-dimensional (3D) volume with volume elements (voxels) indexed by three spatial coordinates (x, y, z). In one example, FIG. 2 illustrates an example 3-Dimensional (3D) volume graphical representation 200 with a voxel as a function of three spatial coordinates (x, y, z).

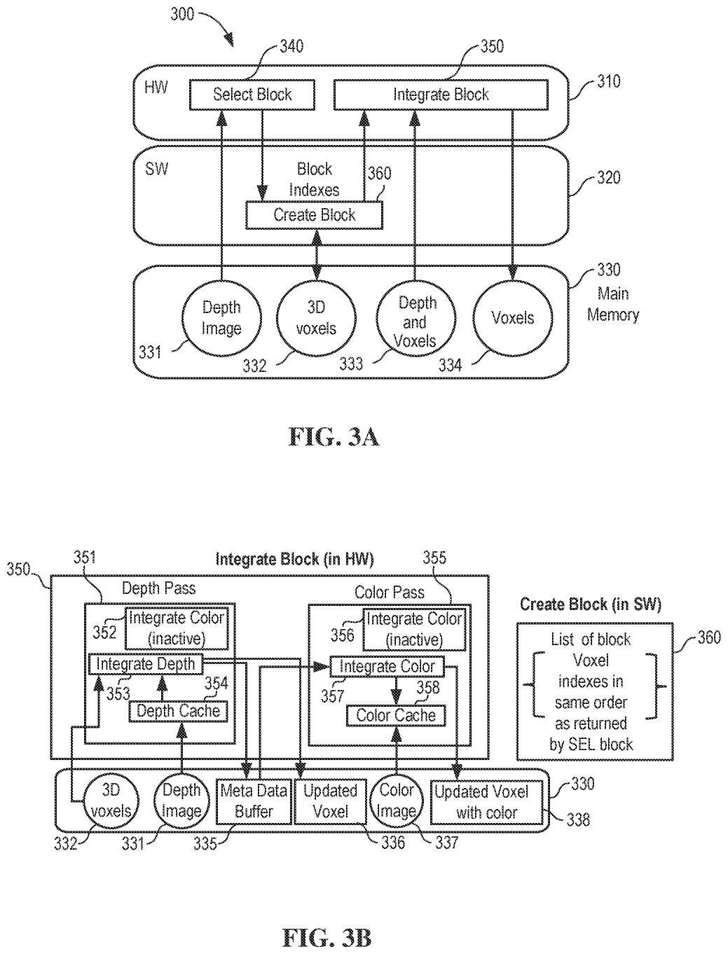

FIG. 3A illustrates a second example information processing system 300. In one example, the information processing system 300 includes a hardware (HW) engine 310, a software (SW) module 320 and a main memory 330 (e.g., a double data rate (DDR) memory). In one example, the hardware engine 310 includes a select block 340 and an integrate block 350. In one example, the software module 320 includes a create block 360. In one example, the main memory 330 includes a depth image 331, a plurality of 3D voxels 332, a depth and voxel set 333, and a plurality of voxels 334.

FIG. 3B illustrates the example information processing system 300 of FIG. 3A with added detail to the integrate block 350, the create block 360 and the main memory 330. In FIG. 3B, the integrate block 350 and associated components are shown with further details. Similarly, the create block 360 is expanded with added text, and the main memory 330 is also expanded with additional components. In one example, the integrate block 350 includes a depth pass module 351 and a color pass module 355. In one example, the depth pass module 351 includes a first integrate color submodule 352, an integrate depth submodule 353 and a depth cache memory 354. In one example, the color pass module 355 includes a second integrate color submodule 356, a third integrate color submodule 357 and a color cache memory 358.

In one example, the depth pass module 351 includes a depth cache memory 354 which serves as a system cache. Whenever the depth image 331 is processed by the depth pass module 351, the depth image 331 is processed pixel by pixel. For each pixel, the depth pass module 351 checks if the corresponding value is stored in the depth cache memory 354. If the corresponding value is stored, it is processed with no delay. However, if the corresponding value is not present in the depth cache memory 354, then the depth pass module 351 sends a request to the main memory 330 to retrieve the corresponding value prior to processing it. This memory request involves additional latency. The depth pass module 351 performs this step for the depth image 331. In one example, the color pass module 355 does the same processing as the depth pass module 351, except with a color cache memory 358 and a color image 337.

In one example, the integrate block 350 exchanges data with the main memory 330 with the following memory elements: 3D voxels 332, depth image 331, meta data buffer 335, updated voxels 336, color image 337 and updated voxels with color 338.

In one example, the create block 360 includes a list of input block voxel indices which are in the same order as returned by the select block 310.

In one example, the select block 340 retrieves the depth image 331 from the main memory 330. In one example, the select block 340 sends input block voxel indices to the create block 360 in the software module 320. In one example, the create block 360 sends a list of input block voxel indices to the integrate block 350. In one example, the integrate block 350 retrieves the depth and voxels 333 from the main memory 330 and produces and sends the voxels 334 to the main memory 330.

In one example, the integrate block 350 includes the depth pass module 351 which retrieves the 3D voxels 332 and depth image 331 from main memory 330 and delivers integrate depth data from the integrate depth submodule 353 to the meta data buffer 335 and to the updated voxel module 336. The integrate block 350 may also include the depth cache memory 354 which receives depth image data from the main memory 330 and sends the depth image data to the integrate depth submodule 353. The depth pass module 351 may also include the first integrate color submodule 352 which may be inactive.

In one example, the integrate block 350 includes the color pass module 355 which retrieves the integrate depth data from the meta data buffer 335 in the main memory 330 and delivers the integrate depth data to the third integrate color submodule 357. The color pass module 355 may also retrieve the color image 337 from the main memory 330 and deliver the color image 337 to the color cache memory 358. The third integrate color submodule 357 may receive the color image 337 from the color cache memory 358 and delivers the updated voxel with color 338 to the main memory 330 based on the color image 337 and the integrate depth data. The color pass module 355 may also include the second integrate color submodule 356 which may be inactive.

In one example, an output block list returned by the select block 340 of FIG. 3A includes block voxel indices (e.g., x, y, z) in a random order. In one example, the input block voxel indices in random order are passed to the integrate block 350. As a result, sample pixel locations (x, y) contained in the input block voxel indices (x, y, z) are also fetched in random order.

In one example, the example information processing system 300 maps a pixel (x, y) to a cache memory tile. For example, the mapping may be of the form: “i=(tile_w % 4)*32+tile_h % 32”, where tile_w=x/64 and tile_h=y/4. In one example, the cache memory size is limited (e.g., 384 kilobits) and a plurality of pixels in a particular voxel may map to the same tile which results in a collision. In one example, a single cache memory tile may hold data corresponding to 128 depth pixels.

In one example, cache memory in hardware is divided into several tiles (e.g., labeled as 0, 1, 2 . . . total_number_of_tiles). Each pixel (x,y) will be mapped to a particular tile in the cache memory where its value will be stored. In one example, a grid is a division of a pixel frame (2D) into a variable number of smaller regions to which the voxel indices map.

As an illustration, in one example, let i be the cache tile index which corresponds to a first pixel (x, y). Since the cache tile may hold 128 depth pixels, it may also hold data corresponding to neighboring pixels. For example, for these neighboring pixels, a cache request may be a memory hit provided the data remains in the tile. However, since the cache memory size is limited, a second pixel (x′, y′) which is not in the neighborhood of the first pixel (x, y) may be mapped to the same cache tile index i. For example, since this cache tile is already occupied, existing data in the cache memory may need to be flushed and new data may need to be fetched.

In one example, because of the random ordering of the input block voxel indices, for some other voxel, a neighboring pixel of the first pixel (x, y) may be retrieved, but since the cache index i now holds data corresponding to the second pixel (x′, y′), a cache miss may result. In this case, the cache memory may require a subsequent flush and a new fetch may be required. As a result, a cache memory may hit in this scenario due to the random ordering of the voxels. Also, a wasted access request to the main memory may result.

In one example, cache memory performance may be augmented by introducing reordering block logic. For example, voxel coordinates (x, y, z), which are neighbors in a neighborhood region R and map to a 2D image domain (x, y), may not be scattered around in the 2D image. In one example, this feature may be employed to regroup the input block list from the select block such that the input block voxel indices, which have pixel locations closer to each other, are placed together in a reordered list.

In one example, to regroup the input block voxel indices, the 3D image data may be separated into N different grids (e.g., N=16) such that neighboring input block voxel indices in the 3D image data are placed in the same grid. For example, the input block voxel indices may be divided into grids by grouping according to the first coordinate (e.g., x) of the input block voxel indices. For example, the block voxel indices may be divided into grids by grouping according to the second coordinate (e.g., y) of the input block voxel indices. For example, the input block voxel indices may be divided into grids by grouping according to the third coordinate (e.g., z) of the input block voxel indices. In one example, after mapping neighboring block voxel indices to the same grid, the neighboring output block voxel indices that are accessed a plurality of times may be accessed in consecutive output block voxel indices and no longer in a random order.

In one example, the regrouping logic ensures that a cache tile flush corresponding to a pixel (x, y) will not need to be fetched again. This feature changes the cache memory hit ratio (e.g., increases the cache memory hit ratio) while changing area, bandwidth and/or power (e.g., reducing area, bandwidth and/or power).

In one example, the regrouping logic may be performed in software for all input block voxel indices for a first frame. Subsequently, the regrouping logic may be performed for new input block voxel indices. For example, latency change (e.g., increase latency) may be minimized since no resorting is performed, only regrouping of the block voxel indices.

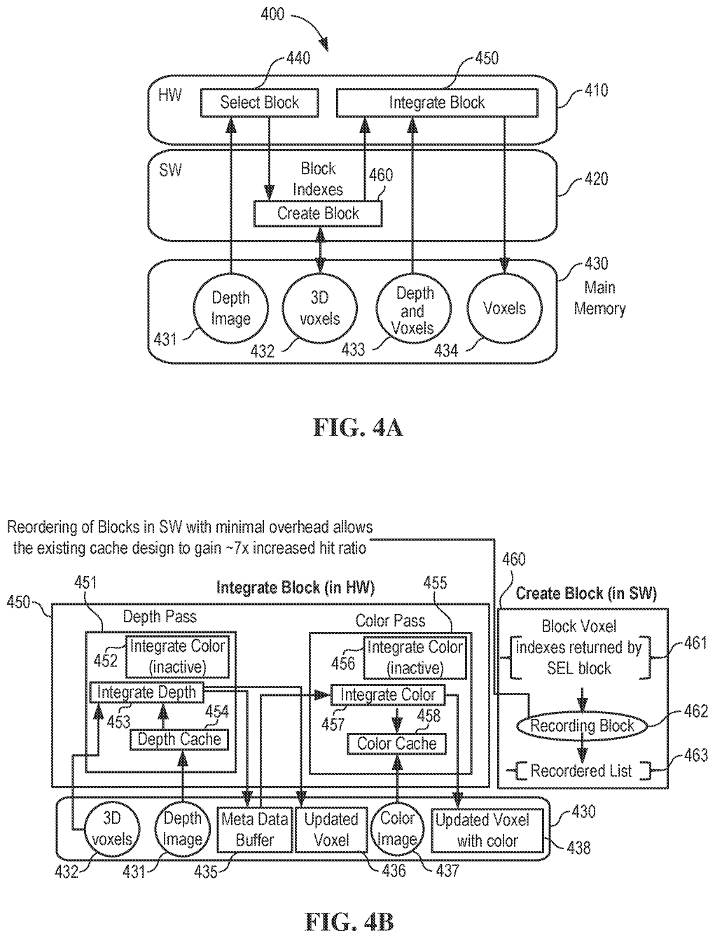

FIG. 4A illustrates a third example information processing system 400. In one example, the second example information processing system 400 includes a hardware (HW) engine 410, a software (SW) module 420 and a main memory 430 (e.g., a double data rate (DDR) memory). In one example, the hardware engine 410 includes a select block 440 and an integrate block 450. In one example, the software module 420 includes a create block 460. In one example, the main memory 430 includes a depth image 431, a plurality of 3D voxels 432, a depth and voxel set 433, and a plurality of voxels 434.

FIG. 4B illustrates the example information processing system of FIG. 4A with added detail to the integrate block, the create block and the main memory 430. In FIG. 4B, the integrate block 450 and associated components are shown with further details. Similarly, the create block 460 is expanded with added text, and the main memory 430 is also expanded with additional components.

In one example, the integrate block 450 includes a depth pass module 451 and a color pass module 455. In one example, the depth pass module 451 includes a first integrate color submodule 452, an integrate depth submodule 453 and a depth cache memory 454. In one example, the color pass module 455 includes a second integrate color submodule 456, an integrate color submodule 457 and a color cache memory 458.

In one example, the integrate block 450 exchanges data with the main memory 430. In one example, the main memory 430 includes one or more of the following: a plurality of 3D voxels 432, a depth image 431, a meta data buffer 435, updated voxels 436, a color image 437 and updated voxels with color 438.

In one example, the create block 460 receives a plurality of input block voxel indices 461 from the select block 440 and sends them to a reordering block 462. In one example, the reordering block 462 reorders the received the plurality of input block voxel indices 461 into a reordered list 463. In one example, the reordering block 462 performs reordering by introducing reordering block logic. For example, the plurality of input block voxel indices which are neighbors in a neighborhood region R and map to a 2D image domain (x, y) may not be scattered around in the 2D image. In one example, voxel coordinates are voxel indices (e.g., x, y, z).

In one example, this feature may be employed to regroup the plurality of input block voxel indices 461 from the select block such that the plurality of input block voxel indices which have pixel locations closer to each other are placed together in the reordered list 463. In one example, input block voxel indices (x, y, z) closer to each other in 3D coordinate space will lie in a similar neighborhood region ‘R’ in the image domain. In one example, the input block list from the select block 440 such that the block voxel indices (x, y, z) that have pixel locations closer to each other are placed together in the list. The input block voxel indices may be divided into grids by grouping based on the ‘x-coordinate of the voxel’ (after grouping based on x, grouping based on y, and finally grouping based on z). That is, all the input block voxel indices with ‘x-coordinate’ that lie in a predefined empirical range are placed in one grid, similarly for ‘y-coordinate’ and ‘z-coordinate’. This new list of data based on the reordering/grouping of input block voxel indices structures them in a manner which may reduce the cache request to the main memory 430 for pixel data. Instead of blindly accessing the input block voxel indices, this reordering technique may improve the overall system performance and accuracy.

In one example, the select block 440 retrieves the depth image 431 from the main memory 430. In one example, the select block 440 sends the plurality of input block voxel indices to the create block 460 in the software module 420. In one example, the create block 460 sends the reordered list 463 to the integrate block 450. In one example, the integrate block 450 retrieves the depth and voxels 433 from the main memory 430 and produces and sends the voxels 434 to the main memory 430.

In one example, the integrate block 450 includes the depth pass module 451 which retrieves the 3D voxels 432 and depth image 431 from main memory 430 using the reordered list 463 and delivers depth image data from the integrate depth submodule 453 to the meta data buffer 435 and to the updated voxel module 436. The integrate block 450 also includes the depth cache memory 454 which receives depth image data from the main memory 430 and sends the depth image data to the integrate depth submodule 453. The depth pass module 451 also includes the first integrate color submodule 452 which may be inactive.

In one example, the integrate block 450 includes the color pass module 455 which retrieves the integrate depth data from the meta data buffer 435 in the main memory 430 and delivers the integrate depth data to the integrate color submodule 457. The color pass module 455 also retrieves the color image 437 from the main memory 430 and delivers the color image 437 to the color cache memory 458. The integrate color submodule 457 receives the color image 437 from the color cache memory 458 and delivers the updated voxel with color 438 to the main memory 430 based on the color image 437 and the integrate depth data. The color pass module 455 also includes the second integrate color submodule 456 which may be inactive.

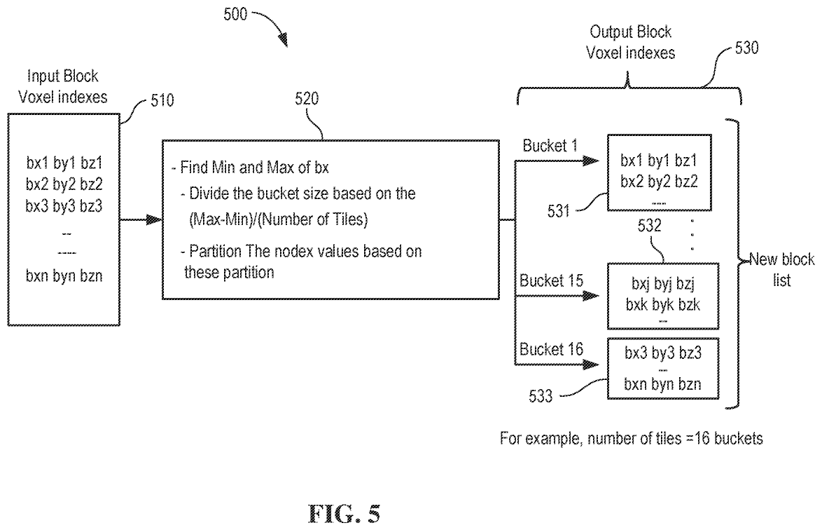

FIG. 5 illustrates an example preprocessing block 500. In one example, an input block voxel indices module 510 contains a list of input block voxel indices (e.g., 3D spatial coordinates) bxi, byi, bzi, where i=1 to n. For example, the list of input block voxel indices specifies 3D spatial coordinates for voxels. In one example, a voxel partition module 520 separates the input block voxel indices by first determining a minimum and a maximum of a first spatial coordinate of the 3D spatial coordinates (e.g., bxi, byi, or bzi) and then dividing the bucket size based on the ratio of the difference of maximum and minimum over the number of tiles. Next, the voxel partition module 520 separates the first, second or third spatial coordinate of 3D coordinates based on the division of the bucket size to generate separated coordinates.

In one example, an output block voxel indices module 530 accepts the separated coordinates and segregates them into a plurality of buckets. For example, a bucket is a group of output block voxel indices. For example, in FIG. 5, bucket 1 531 contains spatial coordinates (bx1, by1, bz1) and (bx2, by2, bz2), bucket 15 532 contains spatial coordinates (bxj, byj, bzj) and (bxk, byk, bzk), and bucket 16 533 contains spatial coordinates (bx3, by3, bz3) and (bxn, byn, bzn). For example, the number of tiles equals the number of buckets (e.g., 16).

In one example, the separation may be extended by grouping on a second spatial coordinate of 3D coordinates after separation based on the first spatial coordinate to form a hierarchical grouping. In one example, the separation may be further extended by grouping on a third spatial coordinate of 3D coordinates after separation based on the first spatial coordinate and the second spatial coordinate.

In one example, implementation of the reordering logic may be performed by various techniques. For example, a first technique may be based on a cache memory using a virtual array. In one example, a second technique is extended from the first technique by adding the reordering logic. In one example, the second technique may modify the memory hit ratio by a factor of 7 for an average case by changing misses from 57,000 to 8380 and changing bandwidth from 14.6 Mbits/sec to 2.1 Mbits/sec.

In one example, a third technique modifies the first technique by keeping the same area. For example, the first technique may have 384 cache lines and 1024 cache tiles for a total area of 384 kbits. For example, the third technique may have 1024 cache lines and 384 cache tiles for the same total area of 384 kbits. As a result, more neighboring pixels may be stored in a single cache line. In one example, the third technique may modify the memory hit ratio by a factor of 62 for an average case by changing misses from 57,000 to 912 and changing bandwidth from 14.6 Mbits/sec to 0.93 Mbits/sec.

In one example, a fourth technique modifies the baseline design by changing area (e.g., reducing area by 50%.) For example, the fourth technique may have 1024 cache lines and 192 cache tiles for a changed area (e.g., reduced area of 192 kbits). In one example, the fourth technique may modify the memory hit ratio by a factor of 4 for an average case by changing misses from 57,000 to 15,000 while changing area by half and maintaining bandwidth with a slight marginal change from 14.6 Mbits/sec to 15.4 Mbits/sec.

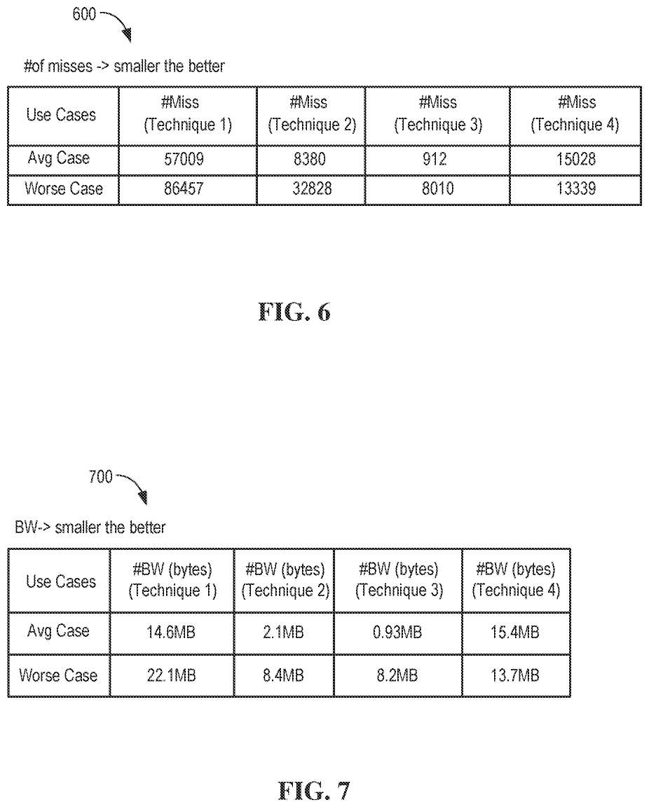

FIG. 6 illustrates an example 600 of a miss performance for an average case and a worst case. The miss performance is shown for the first technique, the second technique, the third technique and the fourth technique. The miss performance is better with a smaller quantity.

FIG. 7 illustrates an example 700 of a bandwidth performance for an average case and a worst case. The bandwidth performance is shown for the first technique, the second technique, the third technique and the fourth technique. The bandwidth performance is better with a smaller quantity.

In one example, incorporation of the reordering logic to the cache memory design may have several performance benefits. For example, a benefit may be changed memory hit ratio. For example, reordering of input block voxel indices may change the memory hit ratio of the cache memory. For example, after reordering, once data corresponding to a cache tile is flushed, it is not fetched again which changes the number of memory fetches.

In one example, another benefit may be a changed area (e.g., reduced area). For example, with the changed memory hit ratio, the area of the cache memory may be changed since outstanding transaction (OT) performance may be met with a changed area. For example, changed area (e.g., reduced area) may translate to lower cost for the cache memory.

In one example, another benefit may be changed bandwidth, changed power and changed outstanding transaction (OT) metric. For example, since the number of transactions is changed, the bandwidth may also be changed (e.g., reduced) which leads to change power consumption for 3-D Reconstruction Intellectual Property (3DRIP) (e.g., a 3-D reconstruction firmware implementation) and a changed OT metric.

In one example, another benefit may be a changed digital signal processing (DSP) time. For example, reordering of input block voxel indices based on separation may be faster than generic sorting since there is lower time complexity. In one example, the separation is based on division of bucket size.

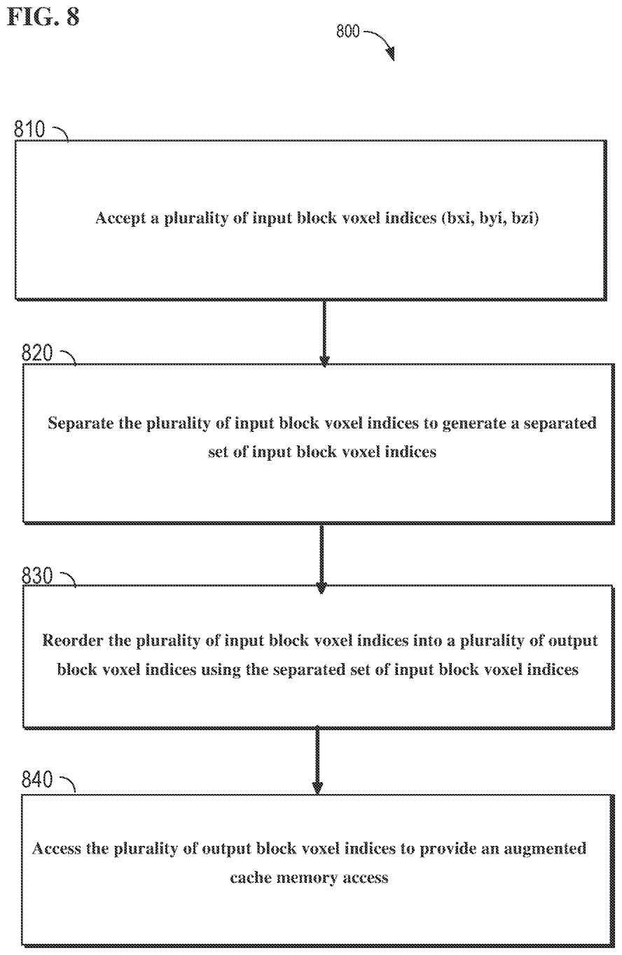

FIG. 8 illustrates an example flow diagram 800 for reordering a plurality of input block voxel indices in a cache memory. In block 810, accept a plurality of input block voxel indices (bxi, byi, bzi) from a cache memory. That is, a plurality of input block voxel indices (bxi, byi, bzi) is accepted, for example, from the cache memory. In one example, each input block voxel index of the plurality of input block voxel indices provides an addressing label to a three-dimensional (3D) image data. In one example, the 3D image data is a function of three spatial coordinates, for example, x, y, z. In one example, each element of 3D image data may be addressed or indexed by a particular spatial coordinate known as a volume element or voxel.

In block 820, separate the plurality of input block voxel indices to generate a separated set of input block voxel indices. That is, the plurality of input block voxel indices is separated to generate a separated set of input block voxel indices. In one example, the 3D image data may be separated into N different grids (e.g., N=16) such that neighboring input block voxel indices of the plurality of input block voxel indices in the 3D image data are placed in the same grid.

In one example, the plurality of input block voxel indices may be divided into a plurality of grids by grouping each of the plurality of input block voxel indices according to each first spatial coordinate (e.g., x) of the each plurality of input block voxel indices. In one example, the plurality of input block voxel indices may be divided into a plurality of grids by grouping each of the plurality of input block voxel indices according to each second spatial coordinate (e.g., y) of the each plurality of input block voxel indices. In one example, the plurality of input block voxel indices may be divided into a plurality of grids by grouping each of the plurality of input block voxel indices according to each third spatial coordinate (e.g., z) of the each plurality of input block voxel indices.

In one example, the separation separates the plurality of input block voxel indices by determining a minimum and a maximum of a plurality of first spatial coordinates (e.g., x) of the plurality of input block voxel indices, and then by dividing the bucket size based on the ratio of the difference of maximum and minimum over the quantity of tiles.

In one example, the separation separates the plurality of input block voxel indices by determining a minimum and a maximum of a plurality of second spatial coordinates (e.g., y) of the plurality of input block voxel indices, and then by dividing the bucket size based on the ratio of the difference of maximum and minimum over the quantity of tiles.

In one example, the separation separates the plurality of input block voxel indices by determining a minimum and a maximum of a plurality of third spatial coordinates (e.g., z) of the plurality of input block voxel indices, and then by dividing the bucket size based on the ratio of the difference of maximum and minimum over the quantity of tiles.

In one example, the separation separates the first, second or third spatial coordinates based on the division of the bucket size to generate a separated set of input block voxel indices. In one example, the separation may be extended by grouping the first, the second and the third spatial coordinates in an arbitrary order to form a hierarchical grouping.

In block 830, reorder the plurality of input block voxel indices into a plurality of output block voxel indices using the separated set of input block voxel indices. That is, the plurality of input block voxel indices is reordered into a plurality of output block voxel indices using the separated set of input block voxel indices. In one example, the reordering segregates the separated set of input block voxel indices into a plurality of buckets. For example, a bucket is a group of output block voxel indices.

In block 840, access the plurality of output block voxel indices to provide an augmented cache memory access. That is, the plurality of output block voxel indices is accessed to provide an augmented cache memory access. In one example, the plurality of output block voxel indices allows more efficient memory access of the 3D image data.

In one aspect, one or more of the steps for providing cache memory architecture augmentation for 3-D data in FIG. 8 may be executed by one or more processors which may include hardware, software, firmware, etc. The one or more processors, for example, may be used to execute software or firmware needed to perform the steps in the flow diagram of FIG. 8. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a create block configured to receive a plurality of input block voxel indices and configured to generate a reordered list based on the plurality of input block voxel indices; and
an integrate block coupled to the create block, the integrate block configured to use the reordered list to deliver integrate depth data for generating a plurality of output block voxel indices.

2. The apparatus of claim 1, further comprising a select block coupled to the create block, the select block configured to send the plurality of input block voxel indices to the create block.

3. The apparatus of claim 2, further comprising a memory coupled to the create block, the memory configured for storing the plurality of input block voxel indices.

4. The apparatus of claim 3, wherein the create block includes a reordering block, the reordering block configured to generate the reordered list.

5. The apparatus of claim 3, wherein the memory is configured to store one or more of the following: a depth image, one or more 3D voxels, a depth and voxel set, one or more voxels, a meta data buffer, an updated voxel, a color image, or an updated voxel with color.

6. The apparatus of claim 3, wherein the integrate block includes a depth pass module, the depth pass module configured to receive a depth image and one or more 3D voxels, and the depth pass module further configured to generate a depth image data based on the depth image and the one or more 3D voxels.

7. The apparatus of claim 6, wherein the depth pass module is further configured to deliver the depth image data to a meta data buffer.

8. The apparatus of claim 7, wherein the meta data buffer is a component of the memory.

9. The apparatus of claim 7, wherein integrate block includes a color pass module, the color pass module configured to receive the depth image data from the meta data buffer, and further configured to generate an updated voxels with color based on the depth image data.

10. The apparatus of claim 9, wherein the color pass module includes a color cache memory, the color cache memory configured to receive a color image for the generation of the updated voxels with color.

11. A method comprising:
reordering a plurality of input block voxel indices into a plurality of output block voxel indices using a separated set of input block voxel indices; and
accessing the plurality of output block voxel indices to provide an augmented cache memory access.

12. The method of claim 11, further comprising separating the plurality of input block voxel indices to generate the separated set of input block voxel indices.

13. The method of claim 12, further comprising accepting the plurality of input block voxel indices from a cache memory.

14. The method of claim 13, wherein the cache memory is a component of a main memory.

15. The method of claim 13, wherein each of the plurality of input block voxel indices provides an addressing label to a three-dimensional (3D) image data.

16. The method of claim 15, further comprising separating the 3D image data into N different grids.

17. The method of claim 16, wherein N is 16 different grids.

18. The method of claim 16, wherein neighboring input block voxel indices of the plurality of input block voxel indices in the 3D image data are placed in a same grid.

19. The method of claim 13, further comprising dividing the plurality of input block voxel indices into a plurality of grids by grouping each of the plurality of input block voxel indices according to each first spatial coordinate (x) of the each plurality of input block voxel indices.

20. The method of claim 13, further comprising dividing the plurality of input block voxel indices into a plurality of grids by grouping each of the plurality of input block voxel indices according to each second spatial coordinate (y) of the each plurality of input block voxel indices.

21. The method of claim 13, further comprising dividing the plurality of input block voxel indices into a plurality of grids by grouping each of the plurality of input block voxel indices according to each third spatial coordinate (z) of the each plurality of input block voxel indices.

22. The method of claim 11, further comprising separating the plurality of input block voxel indices by determining a minimum and a maximum of a plurality of spatial coordinates of the plurality of input block voxel indices.

23. The method of claim 22, wherein the plurality of spatial coordinates is one of:
a) a plurality of a first spatial coordinates (x);
b) a plurality of a second spatial coordinates (y); or
c) a plurality of a third spatial coordinates (z).

24. The method of claim 23, further comprising dividing a bucket size based on a ratio of a difference of the maximum and the minimum over a quantity of tiles.

25. An apparatus comprising:
means for accepting a plurality of input block voxel indices from a cache memory;
means for separating the plurality of input block voxel indices to generate a separated set of input block voxel indices;
means for reordering the plurality of input block voxel indices into a plurality of output block voxel indices using the separated set of input block voxel indices; and
means for accessing the plurality of output block voxel indices to provide an augmented cache memory access.

26. The apparatus of claim 25, further comprising means for separating a 3-Dimensional (3D) image data into 16 different grids, wherein neighboring input block voxel indices of the plurality of input block voxel indices in the 3D image data are placed in a same grid.

27. The apparatus of claim 25, further comprising means for separating the plurality of input block voxel indices by determining a minimum and a maximum of a plurality of spatial coordinates of the plurality of input block voxel indices, wherein the plurality of spatial coordinates is one of:
a) a plurality of a first spatial coordinates (x);
b) a plurality of a second spatial coordinates (y); or
c) a plurality of a third spatial coordinates (z).

28. The apparatus of claim 27, further comprising means for dividing a bucket size based on a ratio of a difference of the maximum and the minimum over a quantity of tiles.

29. A non-transitory computer-readable medium storing computer executable code, operable on a device comprising at least one processor and at least one memory coupled to the at least one processor, wherein the at least one processor is configured to implement reordering a plurality of input block voxel indices in a cache memory, the computer executable code comprising:
instructions for causing a computer to accept the plurality of input block voxel indices from the cache memory;
instructions for causing the computer to separate the plurality of input block voxel indices to generate a separated set of input block voxel indices;
instructions for causing the computer to reorder the plurality of input block voxel indices into a plurality of output block voxel indices using the separated set of input block voxel indices; and
instructions for causing the computer to access the plurality of output block voxel indices to provide an augmented cache memory access.

30. The non-transitory computer-readable medium of claim 29, further comprising:
instructions for causing the computer to separate the plurality of input block voxel indices by determining a minimum and a maximum of a plurality of spatial coordinates of the plurality of input block voxel indices, wherein the plurality of spatial coordinates is one of:
a) a plurality of a first spatial coordinates (x);
b) a plurality of a second spatial coordinates (y); or
c) a plurality of a third spatial coordinates (z); and
instructions for causing the computer to divide a bucket size based on a ratio of a difference of the maximum and the minimum over a quantity of tiles.
